(19) United States
(12) Patent Application Publication
(10) Pub. No.: US 2025/0212871 A1
(43) Pub. Date: Jul. 3, 2025

(54) DEVICES, SYSTEMS, AND METHODS FOR CONTAINMENT OF AN ORGAN EX VIVO AND CONFLUENT DISTRIBUTION OF AN ULTRASOUND FIELD

(71) Applicant: UNIVERSITY OF PITTSBURGH-OF THE COMMONWEALTH SYSTEM OF HIGHER EDUCATION, Pittsburgh, PA (US)

(72) Inventors: Christopher B. HUGHES, Pittsburgh, PA (US); Flordeliza S. VILLANUEVA, Pittsburgh, PA (US); Xucai CHEN, Pittsburgh, PA (US); Yermek NIGMET, Pittsburgh, PA (US)

(21) Appl. No.: 18/851,818

(22) PCT Filed: Mar. 29, 2023
(86) PCT No.: PCT/US2023/016699

§ 371 Date: Sep. 27, 2024

Related U.S. Application Data
(60) Provisional application No. 63/324,771, filed on Mar. 29, 2022.

(51) Int. Cl. A01N 1/168; A01N 1/122; A01N 1/143

(52) U.S. Cl. CPC A01N 1/168; A01N 1/122; A01N 1/143

(57) ABSTRACT

A device for containment of an organ ex vivo and confluent distribution of an ultrasound field to the organ during ex vivo machine perfusion may include a container, a plurality of ultrasound transducers mounted to the container, and a power generator in operable communication with each of the ultrasound transducers. The container may define a reservoir and a plurality of apertures extending through a wall of the container and in communication with the reservoir, with the reservoir being configured for receiving the organ therein. Each of the ultrasound transducers may extend through a respective aperture of the plurality of apertures and may be configured for delivering ultrasound energy into the reservoir and to a respective portion of the organ therein. The power generator may be configured for selectively powering the ultrasound transducers to deliver ultrasound energy.

### CROSS-REFERENCE TO RELATED APPLICATION

This application claims the benefit of priority to U.S. Provisional Application No. 63/324,771 filed on Mar. 29, 2022, which is herein incorporated by reference in its entirety for all purposes.

### FIELD OF THE DISCLOSURE

The present disclosure relates generally to techniques for preserving or enhancing organs and more particularly to devices, systems, and methods for preserving or enhancing organs ex vivo during machine perfusion using microbubble infusion combined with an ultrasound field.

### BACKGROUND OF THE DISCLOSURE

Ex vivo machine perfusion has been recognized as one of the most significant recent advances in the field of transplantation, particularly for kidney and lung transplantation, allowing more “marginal” organs to be transplanted with greater confidence that outcomes will be acceptable. For liver transplantation, the Food and Drug Administration has recently approved (September 2021) clinical use of the TransMedics organ care system (OCS) for normothermic, oxygenated machine perfusion. With the increase in the percentage of livers from donors after circulatory death (DCD), this machine perfusion device, as well other unapproved devices like it, has been touted to help prevent the dreaded post-transplant complication of ischemic cholangiopathy (IC). Although machine perfusion has decreased the incidence of IC in initial clinical trials, the risk is still high, leading to surgeon reluctance in using DCD livers unless warm ischemia time is very short.

Donation after circulatory death is a category of deceased donor that is on the rise compared to donation after brain death, primarily due to advances in treatment of neurological injuries, for instance with hypothermia protocols, and also due to the dramatic rise in drug overdoses, often leading to permanent brain injury but not brain death. The process of donation after circulatory death, where there is a period of hypotension, hypoxia, and blood stagnation during the process of natural progression to circulatory death, leads to widespread microthrombi formation throughout the donor's body before organs can be procured. For the liver, this microthrombi formation is particularly difficult to rid from the peribiliary vascular plexus, the dense, multi-layered meshwork of microvasculature with high-levels of blood and oxygen flow to the sensitive cholangiocytes of the biliary tree. Attempts to remove the plugging from the peribiliary vasculature after DCD procurement have been met with limited success. Without removing these microthrombi, reperfusion at the time of transplantation does not occur to segments of the biliary vasculature, leading to segmental biliary death, stricturing, obstruction, and abscess formation, all of which make up the complication of ischemic cholangiopathy. Ischemic cholangiopathy manifests 30-90 days after transplant and is irreversible, requiring extensive medical and endoscopic treatment and subsequent reoperation or retransplantation. This is costly for the patient but also for payors. The medical care for end-stage liver disease patients averages $1,805/month, with average transplant charges being between $240K and S550K depending on the severity of illness at the time of transplantation. The medical costs for retransplantation often exceed $1M.

Liver transplant is the only cure for end stage liver disease (ESLD). The liver is the second most common organ transplanted after kidneys (OPTN Data as of Jan. 26, 2022). OPTN reports over 11,000 people in the United States currently on the waiting list for liver transplant (OPTN Data as of Jan. 26, 2022). In 2021, there were 13,863 deceased donors, of which 4,188 were donors after circulatory death (DCD). From the 9,674 donors after brain death (DBD), 8,247 livers were transplanted, equating to a DBD liver transplant rate of 95%. Contrarily, of the 4,188 DCD donors, only 1,293 livers were transplanted, a utilization rate of only 30% (OPTN Data as of Jan. 26, 2022). It has been estimated that 10% of all donated livers and 30-50% of DCD livers are considered unsuitable for transplantation due to a prolonged ischemic insult to the biliary system (Orman et al., Liver Transplant. 21:1040-1050, 2015). DCD livers carry a high risk of microthrombi in the biliary vasculature leading to IC. The present inventors' own work has shown that these are not true thrombi, but “plugs” of cells in the liver's macro and microvasculature, which form during the process of progression to asystole in the donor (Hughes et al., unpublished data). IC is caused by occlusion of the small blood vessels supplying the donor bile ducts through the peribiliary plexus (PBP), which prevents blood and oxygen from reaching the biliary tree effectively once the liver is transplanted, a type of no reflow phenomenon. IC is a consequence of major ischemia reperfusion injury to the cholangiocytes, which have a low threshold for hypoxemia. IC manifests clinically with segmental necrosis throughout the biliary tree weeks to months after transplantation (Mateo et al., Am. J. Transplant. 6:791-796, 2006). The patients experiencing this complication may require repeated biliary drainage procedures, experience episodes of biliary sepsis, require retransplantation, or die of allograft failure and/or infection.

Livers from DCD donors are projected to account for 40% of the total donor pool by 2030 (Orman et al., Liver Transplant. 19:59-68, 2013). DCD donors could provide thousands of additional suitable livers each year with improved management ex-vivo after the initial organ recovery (Wertheim et al., Am. J. Transplant. 11:1773-1784, 2011). Considering that DCD organs are the largest source of potentially transplantable livers and the largest source of routinely discarded organs, there is a need to minimize the risks of IC and improve the utilization of DCD livers.

Currently, no process or technology has prevented the development of IC after liver transplantation. Although ex-vivo machine perfusion has helped to mitigate some of the risk, the potential for this complication remains a significant deterrent to the more widespread use of DCD organs. Many processes have been tried to rid the hepatic microvasculature of thrombus, including high-pressure flush, retrograde flush, perfusion of thrombolytics, use of vasodilators, and a myriad of low viscosity perfusate solutions. None of these approaches has prevented ischemic cholangiopathy.

A need therefore exists for improved devices and methods for preserving or enhancing organs, for example, prior to transplantation, which may overcome one or more or the above-mentioned challenges associated with existing techniques.

### SUMMARY OF THE DISCLOSURE

The present disclosure provides devices, systems, and methods for containment of an organ ex vivo and confluent distribution of an ultrasound field to the organ during ex vivo machine perfusion.

In one aspect, a device for containment of an organ ex vivo and confluent distribution of an ultrasound field to the organ during ex vivo machine perfusion is provided. In one embodiment, the device may include a container. a plurality of ultrasound transducers mounted to the container, and a power generator in operable communication with each of the ultrasound transducers. The container may define a reservoir and a plurality of apertures extending through a wall of the container and in communication with the reservoir, with the reservoir being configured for receiving the organ therein. Each of the ultrasound transducers may extend through a respective aperture of the plurality of apertures and may be configured for delivering ultrasound energy into the reservoir and to a respective portion of the organ therein. The power generator may be configured for selectively powering the ultrasound transducers to deliver ultrasound energy.

In some embodiments, the container may be a bowl-shaped container having an open top. In some embodiments, the container may have an elliptical or ovoid shape. In some embodiments, the wall of the container may be rigid. In some embodiments, the wall of the container may be flexible. In some embodiments, each of the ultrasound transducers may be adjustably mounted to the container such that an orientation or a position of the ultrasound transducer relative to the container is adjustable. In some embodiments, each of the ultrasound transducers may be adjustably mounted to the container by a plurality of threaded posts, a plurality of springs, and a plurality of nuts. In some embodiments, each of the threaded posts may be fixedly mounted to the container and may extend from an outer surface of the wall of the container, through a respective spring of the plurality of springs, and through a respective hole defined in a flange of the ultrasound transducer, and each of the nuts may be coupled to a respective threaded post of the plurality of threaded posts.

In some embodiments, each of the ultrasound transducers may be a piezoelectric transducer. In some embodiments, each of the ultrasound transducers may include a transducing surface disposed within the reservoir. In some embodiments, the plurality of ultrasound transducers may include four or more ultrasound transducers. In some embodiments, the plurality of ultrasound transducers may include six or more ultrasound transducers. In some embodiments, the plurality of ultrasound transducers may include eight or more ultrasound transducers. In some embodiments, the plurality of ultrasound transducers may include ten or more ultrasound transducers. In some embodiments, the plurality of ultrasound transducers may include twelve or more ultrasound transducers. In some embodiments, the plurality of ultrasound transducers may be spaced apart from one another and arranged in an array about the reservoir.

In some embodiments, the power generator may be in operable communication with each of the ultrasonic transducers by a respective cable extending from the power generator to a transducer connector of the ultrasonic transducer. In some embodiments, the power generator may be configured for selectively powering the ultrasound transducers in sequence individually. In some embodiments, the power generator may be configured for selectively powering the ultrasound transducers in sequence in multiples of two or more. In some embodiments, the power generator may include a switching mechanism configured for selectively switching power delivered to the ultrasound transducers.

In another aspect, a system for containment of an organ ex vivo and confluent distribution of an ultrasound field to the organ during ex vivo machine perfusion is provided. In one embodiment, the system may include a container, a plurality of ultrasound therapy transducers mounted to the container, a therapy power generator in operable communication with each of the ultrasound therapy transducers, and a machine perfusion system. The container may define a reservoir and a plurality of apertures extending through a wall of the container and in communication with the reservoir, with the reservoir being configured for receiving the organ therein. Each of the ultrasound therapy transducers may extend through a respective aperture of the plurality of apertures and may be configured for delivering ultrasound energy into the reservoir and to a respective portion of the organ therein. The power generator may be configured for selectively powering the ultrasound therapy transducers to deliver ultrasound energy. The machine perfusion system may be configured for perfusing the organ with a perfusion solution.

In some embodiments, the container may be a bowl-shaped container having an open top. In some embodiments, the container may have an elliptical or ovoid shape. In some embodiments, the wall of the container may be rigid. In some embodiments, the wall of the container may be flexible. In some embodiments, each of the ultrasound therapy transducers may be adjustably mounted to the container such that an orientation or a position of the ultrasound therapy transducer relative to the container is adjustable. In some embodiments, each of the ultrasound therapy transducers may be adjustably mounted to the container by a plurality of threaded posts, a plurality of springs, and a plurality of nuts. In some embodiments, each of the threaded posts may be fixedly mounted to the container and may extend from an outer surface of the wall of the container, through a respective spring of the plurality of springs, and through a respective hole defined in a flange of the ultrasound therapy transducer, and each of the nuts may be coupled to a respective threaded post of the plurality of threaded posts.

In some embodiments, each of the ultrasound therapy transducers may be a piezoelectric transducer. In some embodiments, each of the ultrasound therapy transducers may include a transducing surface disposed within the reservoir. In some embodiments, the plurality of ultrasound therapy transducers may include four or more ultrasound therapy transducers. In some embodiments, the plurality of ultrasound therapy transducers may include six or more ultrasound therapy transducers. In some embodiments, the plurality of ultrasound therapy transducers may include eight or more ultrasound therapy transducers. In some embodiments, the plurality of ultrasound therapy transducers may include ten or more ultrasound therapy transducers. In some embodiments, the plurality of ultrasound therapy transducers may include twelve or more ultrasound therapy transducers. In some embodiments, the plurality of ultrasound therapy transducers may be spaced apart from one another and arranged in an array about the reservoir.

In some embodiments, the power generator may be in operable communication with each of the ultrasonic therapy transducers by a respective cable extending from the power generator to a transducer connector of the ultrasonic therapy transducer. In some embodiments, the power generator may be configured for selectively powering the ultrasound therapy transducers in sequence individually. In some embodiments, the power generator may be configured for selectively powering the ultrasound therapy transducers in sequence in multiples of two or more. In some embodiments, the power generator may include a switching mechanism configured for selectively switching power delivered to the ultrasound therapy transducers.

In some embodiments, the machine perfusion system may include one or more perfusion pumps configured for delivering the perfusion solution into the organ. In some embodiments, the machine perfusion system may include one or more cannulas configured for insertion into one or more vessels of the organ and directing the perfusion solution into the one or more vessels. In some embodiments, the machine perfusion system may include one or more cannulas configured for insertion into one or more vessels of the organ and withdrawing the perfusion solution from the one or more vessels. In some embodiments, the machine perfusion system may include one or more cannulas configured for insertion into one or more bile ducts of the organ and withdrawing bile from the one or more bile ducts. In some embodiments, the machine perfusion system may include one or more infusion pumps configured for infusing a microbubble-based ultrasound contrast agent into the perfusion solution. In some embodiments, the one or more infusion pumps may be configured for infusing the microbubble-based ultrasound contrast agent into the perfusion solution prior to the perfusion solution entering the organ. In some embodiments, the machine perfusion system may include a temperature regulator configured for regulating a temperature of the perfusion solution. In some embodiments, the machine perfusion system may include an oxygenator configured for oxygenating the perfusion solution.

In some embodiments, the system also may include one or more ultrasound imaging transducers configured for delivering ultrasound energy to at least a portion of the organ for imaging the at least a portion of the organ, and an imaging power generator in operable communication with the one or more ultrasound imaging transducers and configured for selectively powering the one or more ultrasound imaging transducers to deliver ultrasound energy. In some embodiments, the system also may include a sterile sleeve, bag, or drape configured for covering the container and the ultrasound therapy transducers to maintain sterility of the organ within the reservoir.

In still another aspect, a method for containment of an organ ex vivo and confluent distribution of an ultrasound field to the organ during ex vivo machine perfusion is provided. In one embodiment, the method may include positioning the organ within a reservoir of a container, perfusing the organ within the reservoir with a perfusion solution comprising a microbubble-based ultrasound contrast agent, and delivering ultrasound energy to the organ within the reservoir to induce cavitation of microbubbles of the microbubble-based ultrasound contrast agent within the organ.

In some embodiments, delivering the ultrasound energy to the organ within the reservoir to induce cavitation of the microbubbles may cause lysis or dislodgement of clots or microthrombi within the organ. In some embodiments, delivering the ultrasound energy to the organ within the reservoir to induce cavitation of the microbubbles may cause formation of transient pores through cell membranes of cells of the organ. In some embodiments, the cells may be endothelial cells. In some embodiments, the cells may be hepatocytes. In some embodiments, the method also may include delivering genetic macromolecules to the cells to traverse the transient pores and enter the cells. In some embodiments, the genetic macromolecules may be configured for affecting transcription or translation of cellular proteins. In some embodiments, the genetic macromolecules may be configured for altering or reducing expression of cellular proteins associated with cell recognition. In some embodiments, the genetic macromolecules may include small-interfering ribonucleic acids. In some embodiments, the method also may include delivering a therapeutic drug to the cells to traverse the transient pores and enter the cells.

In some embodiments, the organ may be suspended in the perfusion solution within the reservoir. In some embodiments, the organ may be suspended in an organ preservation solution within the reservoir, with the organ preservation solution being different from the perfusion solution. In some embodiments, a sterile sleeve, bag, or drape may cover the container to maintain sterility of the organ within the reservoir. In some embodiments, the container may be a bowl-shaped container having an open top. In some embodiments, the container may have an elliptical or ovoid shape. In some embodiments, the container may be rigid. In some embodiments, the container may be flexible.

In some embodiments, perfusing the organ within the reservoir with the perfusion solution may include delivering the perfusion solution into the organ using a machine perfusion system. In some embodiments, perfusing the organ within the reservoir with the perfusion solution may include delivering the perfusion solution into the organ using one or more perfusion pumps. In some embodiments, perfusing the organ within the reservoir with the perfusion solution may include delivering the perfusion solution into the organ using one or more cannulas inserted into one or more vessels of the organ. In some embodiments, the organ may be a liver, and the one or more cannulas may include a cannula inserted into a hepatic artery of the liver. In some embodiments, the organ may be a liver, and the one or more cannulas may include a cannula inserted into a portal vein of the liver. In some embodiments, the organ may be a liver, and the one or more cannulas may include a first cannula inserted into a hepatic artery of the liver and a second cannula inserted into a portal vein of the liver. In some embodiments, the perfusion solution may be delivered into the hepatic artery as a pulsatile flow, and the perfusion solution may be delivered into the portal vein as a continuous flow. In some embodiments, the organ may be a kidney, and the one or more cannulas may include a cannula inserted into a renal artery of the kidney. In some embodiments, the organ may be a heart, and the one or more cannulas may include a cannula inserted into a coronary artery of the heart. In some embodiments, the organ may be a lung, and the one or more cannulas may include a cannula inserted into a pulmonary artery of the lung. In some embodiments, the organ may be a vascularized composite allograft, and the one or more cannulas may include a cannula inserted into an artery of the vascularized composite allograft. In some embodiments, the perfusion solution may include an oxygen carrying fluid.

In some embodiments, each of the microbubbles may include a gas core surrounded by a shell. In some embodiments, the gas core may include air, nitrogen, or a heavy gas. In some embodiments, the gas core may include perfluorocarbon, octafluoropropane, or decafluorobutane. In some embodiments, the shell may include a protein, a sugar, a lipid, or a polymer. In some embodiments, the shell may include albumin or galactose. In some embodiments, the gas core may include octafluoropropane, and the shell may include a lipid. In some embodiments, the gas core may include air or octafluoropropane, and the shell may include albumin. In some embodiments, the gas core may include perfluorocarbon, octafluoropropane, or decafluorobutane, and the shell may include a phospholipid. In some embodiments, the microbubbles may carry therapeutic oligonucleotides. In some embodiments, each of the microbubbles may have a diameter of less than 10 μm. In some embodiments, each of the microbubbles may have a diameter within a range of 1 μm to 4 μm. In some embodiments, the microbubble-based ultrasound contrast agent may be infused into the perfusion solution prior to the perfusion solution entering the organ. In some embodiments, the microbubble-based ultrasound contrast agent may be infused into the perfusion solution using an infusion pump. In some embodiments, the microbubble-based ultrasound contrast agent may be infused into the perfusion solution at a rate within a range of 0.05 ml/min to 1.0 ml/min. In some embodiments, a concentration of the microbubbles in the microbubble-based ultrasound contrast agent prior to infusion into the perfusion solution may be within a range of 1×10⁸/ml to 1×10¹²/ml.

In some embodiments, the microbubble-based ultrasound contrast agent may be continuously infused into the perfusion solution throughout a duration of perfusion of the organ with the perfusion solution. In some embodiments, the microbubble-based ultrasound contrast agent may be infused into the perfusion solution during only one or more portions of a duration of perfusion of the organ with the perfusion solution. In some embodiments, perfusing the organ within the reservoir with the perfusion solution may include delivering the perfusion solution into the organ as a continuous flow having a substantially constant flow rate. In some embodiments, perfusing the organ within the reservoir with the perfusion solution may include delivering the perfusion solution into the organ as a pulsatile flow having periodic increases and decreases in flow rate. In some embodiments, perfusing the organ within the reservoir with the perfusion solution may include simultaneously delivering a first flow of the perfusion solution into the organ as a continuous flow having a substantially constant flow rate and a second flow of the perfusion solution into the organ as a pulsatile flow having periodic increases and decreases in flow rate.

In some embodiments, delivering the ultrasound energy to the organ within the reservoir to induce cavitation of the microbubbles may include inducing stable cavitation of the microbubbles. In some embodiments, delivering the ultrasound energy to the organ within the reservoir to induce cavitation of the microbubbles may include inducing inertial cavitation of the microbubbles. In some embodiments, delivering the ultrasound energy to the organ within the reservoir to induce cavitation of the microbubbles may include delivering one or more bursts of the ultrasound energy to the organ. In some embodiments, each of the one or more bursts of the ultrasound energy may have a duration of more than 4 acoustic cycles. In some embodiments, a frequency of the ultrasound energy may be within a range of 0.5 MHz to 2 MHz. In some embodiments, a frequency of the ultrasound energy may match a resonance of the microbubbles. In some embodiments, a pressure amplitude of the ultrasound energy may be within a range of 0.2 MPa to 2 MPa.

In some embodiments, delivering the ultrasound energy to the organ within the reservoir to induce cavitation of the microbubbles may include delivering the ultrasound energy in a pulsatile manner. In some embodiments, a pulse interval of the ultrasound energy may be within a range of 0.5 seconds to 10 seconds. In some embodiments, a pulse duration of the ultrasound energy may be within a range of 0.1 milliseconds to 5 milliseconds. In some embodiments, delivering the ultrasound energy to the organ within the reservoir to induce cavitation of the microbubbles may include delivering the ultrasound energy continuously or non-continuously for a treatment duration within a range of 1 minute to 60 minutes. In some embodiments, delivering the ultrasound energy to the organ within the reservoir to induce cavitation of the microbubbles may include delivering the ultrasound energy to the entire parenchyma of the organ. In some embodiments, delivering the ultrasound energy to the organ within the reservoir to induce cavitation of the microbubbles may include repeatedly delivering the ultrasound energy to the entire parenchyma of the organ.

In some embodiments, delivering the ultrasound energy to the organ within the reservoir to induce cavitation of the microbubbles may include delivering the ultrasound energy to the organ using a plurality of ultrasound therapy transducers. In some embodiments, the ultrasound therapy transducers may be fixed relative to the organ. In some embodiments, the ultrasound therapy transducers may be mounted to the container. In some embodiments, each of the ultrasound therapy transducers may be adjustably mounted to the container, and the method also may include adjusting an orientation or a position of one or more of the ultrasound therapy transducers relative to the container. In some embodiments, the orientation or the position of the one or more of the ultrasound therapy transducers may be adjusted relative to the container based on a size or a shape of the organ. In some embodiments, each of the ultrasound therapy transducers may be adjustably mounted to the container by a plurality of threaded posts, a plurality of springs, and a plurality of nuts. In some embodiments, each of the threaded posts may be fixedly mounted to the container and may extend from an outer surface of the wall of the container, through a respective spring of the plurality of springs, and through a respective hole defined in a flange of the ultrasound therapy transducer, and each of the nuts may be coupled to a respective threaded post of the plurality of threaded posts.

In some embodiments, the container may define a plurality of apertures extending through a wall of the container and in communication with the reservoir, and each of the ultrasound therapy transducers may extend through a respective aperture of the plurality of apertures. In some embodiments, each of the ultrasound therapy transducers may be a piezoelectric transducer. In some embodiments, each of the ultrasound therapy transducers may include a transducing surface disposed within the reservoir. In some embodiments, the plurality of ultrasound therapy transducers may include four or more ultrasound therapy transducers. In some embodiments, the plurality of ultrasound therapy transducers may include six or more ultrasound therapy transducers. In some embodiments, the plurality of ultrasound therapy transducers may include eight or more ultrasound therapy transducers. In some embodiments, the plurality of ultrasound therapy transducers may include ten or more ultrasound therapy transducers. In some embodiments, the plurality of ultrasound therapy transducers may include twelve or more ultrasound therapy transducers. In some embodiments, the plurality of ultrasound therapy transducers may be spaced apart from one another and arranged in an array about the reservoir.

In some embodiments, delivering the ultrasound energy to the organ within the reservoir to induce cavitation of the microbubbles may include selectively powering the ultrasound therapy transducers using a therapy power generator. In some embodiments, selectively powering the ultrasound therapy transducers using the therapy power generator may include selectively powering the ultrasound therapy transducers in sequence individually. In some embodiments, selectively powering the ultrasound therapy transducers using the therapy power generator may include selectively powering the ultrasound therapy transducers in sequence in multiples of two or more. In some embodiments, selectively powering the ultrasound therapy transducers using the therapy power generator may include selectively powering the ultrasound therapy transducers using a switching mechanism of the therapy power generator. In some embodiments, the therapy power generator may be in operable communication with each of the ultrasonic therapy transducers by a respective cable extending from the therapy power generator to a transducer connector of the ultrasonic therapy transducer. In some embodiments, delivering the ultrasound energy to the organ within the reservoir to induce cavitation of the microbubbles may include providing confluent ultrasound coverage to the organ. In some embodiments, delivering the ultrasound energy to the organ within the reservoir to induce cavitation of the microbubbles may include beginning to deliver the ultrasound energy to the organ a period of time after beginning to perfuse the organ with the perfusion solution, wherein the period of time is sufficient to allow the microbubbles to circulate through the organ. In some embodiments, delivering the ultrasound energy to the organ within the reservoir to induce cavitation of the microbubbles may include delivering the ultrasound energy to the organ for a first period of time. suspending delivery of the ultrasound energy to the organ for a second period of time subsequent the first period of time, wherein the second period of time is sufficient to allow replenishment of the microbubbles circulating within the organ, and delivering the ultrasound energy to the organ for a third period of time subsequent the second period of time. In some embodiments, delivering the ultrasound energy to the organ within the reservoir to induce cavitation of the microbubbles may include delivering the ultrasound energy to the organ while perfusing the organ with the perfusion solution.

In some embodiments, the method also may include allowing the perfusion solution to drain from one or more veins of the organ into the reservoir. In some embodiments, the method also may include draining the perfusion solution from one or more veins of the organ using one or more cannulas inserted into the one or more veins. In some embodiments, the method also may include recirculating the drained perfusion solution into the organ. In some embodiments, the method also may include regulating a temperature of the perfusion solution using a temperature regulator. In some embodiments, the method also may include oxygenating the perfusion solution using an oxygenator. In some embodiments, the method also may include imaging at least a portion of the organ using one or more ultrasound imaging transducers. In some embodiments, the method also may include mapping the ultrasound field delivered to the organ. In some embodiments, the method also may include mapping the ultrasound field delivered to the organ over an image of the organ. In some embodiments, the method also may include mapping the cavitation of the microbubbles within the organ to determine a distribution of the cavitation within the organ.

In some embodiments, the organ may be intended for transplantation in a patient. In some embodiments, the organ may be a liver. In some embodiments, the organ may be a kidney. In some embodiments, the organ may be a heart. In some embodiments, the organ may be a lung. In some embodiments, the organ may be a pancreas. In some embodiments, the organ may be a small intestine. In some embodiments, the organ may be a limb or a portion of a limb. In some embodiments, the organ may be an extremity or a portion of an extremity. In some embodiments, the organ may be a vascularized composite allograft.

These and other aspects and improvements of the present disclosure will become apparent to one of ordinary skill in the art upon review of the following detailed description when taken in conjunction with the several drawings and the appended claims.

### BRIEF DESCRIPTION OF THE DRAWINGS

FIG. 1A is a top view of an example device for containment of an organ ex vivo and confluent distribution of an ultrasound field to the organ during ex vivo machine perfusion in accordance with embodiments of the disclosure, showing a container, a plurality of ultrasound transducers, and a power generator of the device.

FIG. 1B is a side view of the device of FIG. 1A, showing the ultrasound transducers mounted to the container using a plurality of threaded posts, a plurality of springs, and a plurality of nuts and in operable communication with the power generator by a plurality of cables.

FIG. 1C is an opposite side view of the device of FIG. 1A, with one of the ultrasound transducers removed from the container for visualization of an aperture of the container and the threaded posts used for mounting the one of the ultrasound transducers to the container.

FIG. 1D is a front view of one of the ultrasound transducers of the device of FIG. 1A, showing a flange, a transducing surface, and a transducer connector of the ultrasonic transducer.

FIG. 1E is a side view of the one of the ultrasound transducers of the device of FIG. 1A.

FIG. 1F is a top view of the one of the ultrasound transducers of the device of FIG. 1A.

FIG. 1G is a bottom view of the one of the ultrasound transducers of the device of FIG. 1A.

FIG. 1H is a perspective view of the one of the ultrasound transducers of the device of FIG. 1A, showing one of the threaded posts, one of the springs, and one of the nuts used for mounting the one of the ultrasound transducers to the container.

FIG. 1I is a detailed plan view of one of the threaded posts of the device of FIG. 1A.

FIG. 2 is a perspective view of an example use of the device of FIG. 1A for containment of an organ ex vivo and confluent distribution of an ultrasound field to the organ during ex vivo machine perfusion in accordance with embodiments of the disclosure, showing the organ suspended in a perfusion solution within a reservoir of the container, a sterile bag covering the container and the ultrasonic transducers, a plurality of cannulas inserted into vessels of the organ for perfusing the organ, and a cannula inserted into a bile duct of the organ for sample collection.

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. The use of the same reference numerals indicates similar, but not necessarily the same or identical components. Different reference numerals may be used to identify similar components. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

### DETAILED DESCRIPTION OF THE DISCLOSURE

In the following description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional. In some instances, well known methods, procedures, and components have not been described in detail so as not to unnecessarily obscure aspects of the embodiments.

### Overview

Embodiments of devices, systems, and methods for containment of an organ ex vivo and confluent distribution of an ultrasound field to the organ during ex vivo machine perfusion are provided. As described herein, the devices, systems, and methods may be used for sonothrombolysis in an organ ex vivo, for example, prior to transplantation of the organ. Additionally, the devices, systems, and methods may be used for sonoporation in an organ ex vivo, for example, prior to transplantation of the organ.

Sonothrombolysis, a term meaning “sound-induced clot disruption,” is a process currently undergoing pre-clinical and clinical investigation for the in vivo management of thrombotic disorders, for example, in cerebral artery strokes and myocardial infarction. Sonothrombolysis utilizes the shear forces created by microbubble cavitation in an ultrasound field (Pacella et al., Ultrasound Med. Biol. 41:456-464, 2015) to disrupt a clot mechanically. Microbubbles are shells containing a gas, such as a perfluorocarbon or nitrogen gas. Their small size (e.g., smaller than a human red cell) allows them to permeate clots and then cavitate under ultrasound pressure, causing billions of tiny shockwaves, inducing clot disruption (Datta et al., Ultrasound Med. Biol. 34:1421-1433, 2008; Datta et al., Ultrasound Med. Biol. 32:1257-1267, 2006).

Disclosed herein are methods and systems for improving blood or perfusion fluid flow through an organ ex vivo (such as an organ for transplant) by mobilizing diffuse microthrombi, for example, prior to transplantation of the organ. These ex vivo methods and systems utilize the prolonged acoustic activity of ultrasound-stimulated microbubbles to dislodge cellular plugs (e.g., from the peribiliary plexus, in the case of liver). The methods may be performed ex vivo in a non-invasive fashion while allowing the tissue or organ to be effectively perfused and preserved (e.g., using a machine perfusion system). Utilizing a relatively low pulse repetition rate may reduce the total amount of ultrasound energy delivered and also may reduce potentially undesirable effects, such as thermal injury, which would be detrimental to the tissues and to the endothelial cells. One aim of this technology may be to provide a vehicle for confluent ultrasound delivery to an organ, such as the liver, during ex vivo machine perfusion with infusion of microbubbles to effect microbubble cavitation and subsequent clot lysis (sonothrombolysis), such as in the peribiliary plexus, with the goal of improving microvascular perfusion and increasing organs suitable for transplantation.

Sonoporation refers to the use of ultrasound to cause oscillation and cavitation of microbubbles adjacent to a cell surface, such as that of an endothelial cell, whereby the cavitation jet creates a transient opening, or pore, through the cell membrane allowing potential entry of macromolecules. (Helfield et al. Biophysical insight into mechanisms of sonoporation. Proc Natl Acad Sci USA, 2016 Sep. 6: 113(36):9983-8.) For example, sonoporation may be used to introduce genetic macromolecules, such as small-interfering RNAs (siRNA), to traverse the transient pores, enter the cell, and effect transcription or translation of cellular proteins. Such a process may be used to alter or reduce expression of cellular proteins, such as those associated with cell recognition as might be important in transplant allograft recognition leading to rejection. Additionally, the cavitation of the microbubbles may induce endothelial hyperpermeability (and increased transfer of drugs or oligonucleotide payloads) through mechanisms other than sonoporation.

Disclosed herein are methods and systems for sonoporation in an organ ex vivo (such as an organ for transplant), for example, prior to transplantation of the organ. These ex vivo methods and systems utilize the prolonged acoustic activity of ultrasound-stimulated microbubbles to form transient pores through the cell membrane of certain cells (e.g., endothelial cells, hepatocytes, or other cells) of the organ, allowing for subsequent introduction of genetic macromolecules or therapeutic drugs into the cells. The methods may be performed ex vivo in a non-invasive fashion while allowing the tissue or organ to be effectively perfused and preserved (e.g., using a machine perfusion system). One aim of this technology is to provide a vehicle for confluent ultrasound delivery to an organ, such as the liver, during ex vivo machine perfusion including infusion of microbubbles to effect microbubble cavitation and subsequent transient pore formation (sonoporation), such as in the endothelial cells, hepatocytes, or other target cells, to allow introduction of macromolecules such as genetic material or therapeutic drugs prior to transplantation, which may improve allograft function and/or minimize rejection after transplantation.

As discussed above, previous attempts to prevent IC after DCD liver transplantation using different technologies have been unsuccessful. The disclosed technology has the potential to decrease the current organ discard rate by creating new opportunities for the utilization of DCD organs.

Disclosed herein are methods for ex vivo sonothrombolysis including ex vivo perfusing an organ or tissue (e.g., by machine perfusion) with a perfusion medium including at least one microbubble-based ultrasound contrast agent and delivering at least one burst of ultrasound energy to at least a portion of the organ or tissue that is perfused with a perfusion medium comprising the at least one microbubble. In some examples, each of the microbubbles may include octafluoropropane gas surrounded by a lipid shell. The at least one burst of ultrasound energy may be delivered to two or more portions of the organ or tissue by delivering ultrasound energy from one or more transducers that are fixed in place relative to the organ or tissue.

Also disclosed are systems that include an organ perfusion system and at least one ultrasound device (for example, including an ultrasound generator and a transducer). In some examples, the system may include two ultrasound devices, such as one for delivery of ultrasound energy (a “therapy” device) and one for imaging of the organ or tissue (an “imaging” device). The therapy device may include one or more (such as 1, 2, 3, 4, 5, or more) fixed ultrasound probes. In some embodiments, the system also may include an organ or tissue in the perfusion system, such as an organ or tissue that is connected or attached to the perfusion system by one or more cannulas.

Still other features, benefits, and advantages of the devices, systems, and methods provided herein over existing techniques will be appreciated by those of ordinary skill in the art from the following description and the appended drawings.

### Terminology

Unless otherwise explained, all technical and scientific terms used herein have the same meaning as commonly understood by one of ordinary skill in the art to which this disclosure belongs. The singular terms “a,” “an,” and “the” include plural referents unless context clearly indicates otherwise. Similarly, the word “or” is intended to include “and” unless the context clearly indicates otherwise. Although methods and materials similar or equivalent to those described herein can be used in the practice or testing of this disclosure, suitable methods and materials are described below. The term “comprises” means “includes.” All publications, patent applications, patents, and other references mentioned herein are incorporated by reference in their entirety. In case of conflict, the present specification, including explanations of terms, will control. In addition, the materials, methods, and examples are illustrative only and not intended to be limiting. In order to facilitate review of the various embodiments of this disclosure, certain explanations of specific terms are provided below.

Microbubble-based ultrasound contrast agent: A gas core surrounded by a shell. MB are less than 10 um in diameter and are typically smaller than red blood cells and able to enter the microcirculation (for example, about 1-4 μm in diameter). The gas core can be air, nitrogen, or a heavy gas (such as a perfluorocarbon). The shell material may be a protein (such as albumin), a sugar (such as galactose), a lipid, or a polymer.

Organ: A part of the body, tissue, or portion thereof that can be transplanted or preserved ex vivo. Organs include, but are not limited to liver, kidney, heart, lung, pancreas, small intestine, and limb (such as arm or leg, or portion thereof), or extremity (such as hand, foot, finger, toe, or a portion thereof). As used herein, “organ” also includes other tissues, such as tissue grafts or composites (also referred to as vascularized composite allotransplants, composite tissue grafts or composite tissue allotransplants).

Perfusion: Circulation of a fluid (also referred to as a perfusion solution or perfusate) through an organ or composite tissue allograft to supply the needs of the organ or tissue graft to retain its viability (for example, in an ex vivo system).

Machine perfusion: Introduction and/or removal of a perfusion solution to an organ by a mechanical device. Such devices may include one or more chambers for holding an organ and a perfusion solution, one or more pumps for delivery of the perfusion solution to the organ, one or more means to regulate temperature of the perfusion solution, and one or more means to oxygenate the perfusion solution. In some examples, machine perfusion includes introduction of an oxygen carrying fluid, such as blood, into an organ and removal of oxygen depleted fluid from the organ by circulation of the oxygen carrying fluid through the organ. In some embodiments, the perfusion can be pulsatile, with periodic increases and decreases of flow, to mimic arterial blood flow from a beating heart. In other embodiments, the perfusion can be continuous, with a substantial absence of flow rate variations, to mimic venous blood flow under most physiologic conditions.

Ultrasound Transducer: A device that converts an electrical energy to ultrasound energy. In this example, multiple ultrasound transducers (sometimes simply referred to as transducers) are oriented such that the generated ultrasound energy is directed toward an organ in a containment “bowl” or “basin” as that organ undergoes ex vivo machine perfusion such that the organ is subjected, in part or whole, to ultrasound energy.

Cavitation: The process of ultrasound induced oscillation and/or collapse of a microbubble in an ultrasound field as a result of alternating changes in pressure leading to local shear force generation and a release of energy, such as a shock wave and/or heat. The gentler, sustained oscillation under low acoustic pressures is sometimes called stable cavitation, and the more violent oscillation leading to bubble collapse is sometimes called inertial cavitation.

### Example Devices, Systems, and Methods

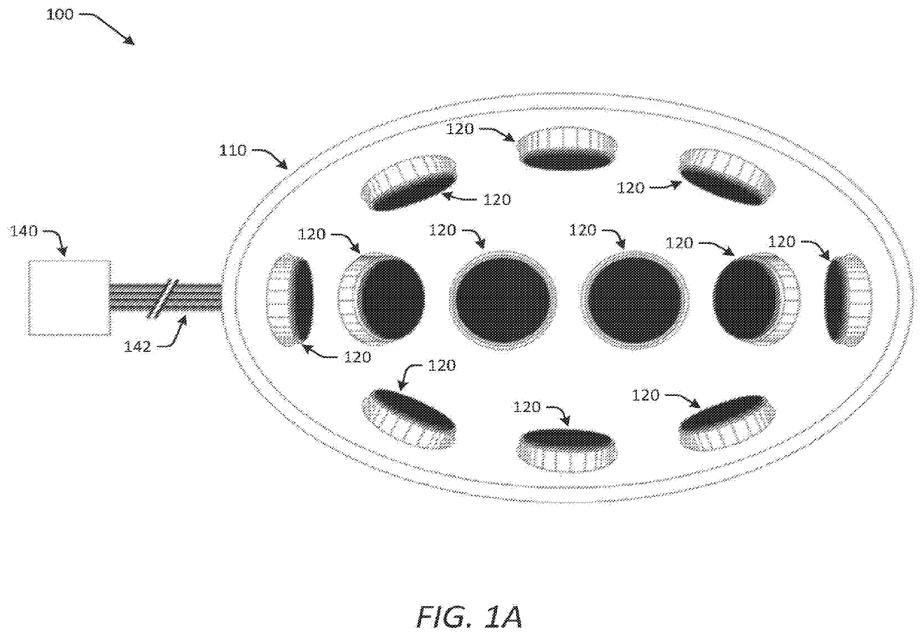

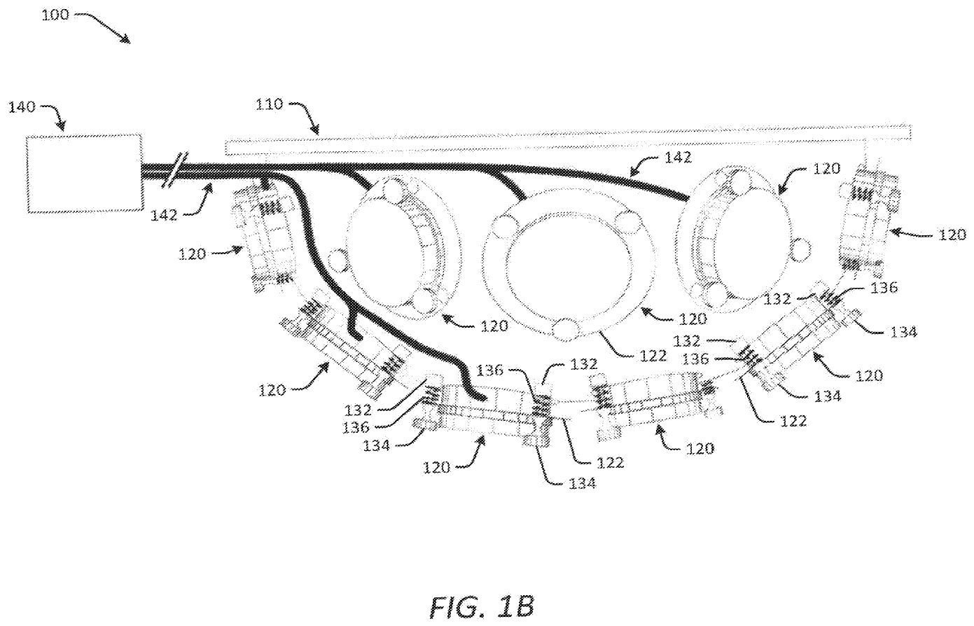

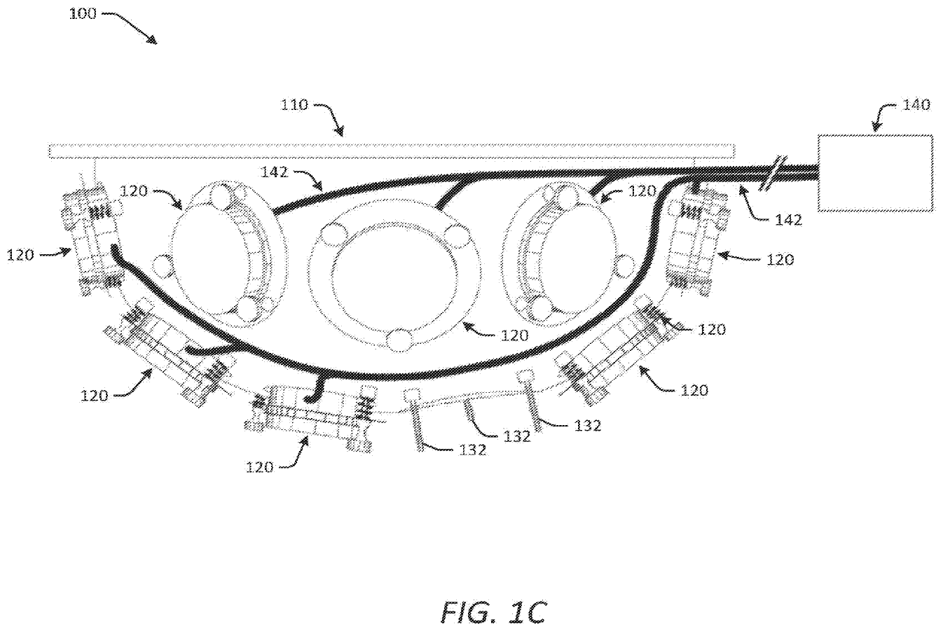

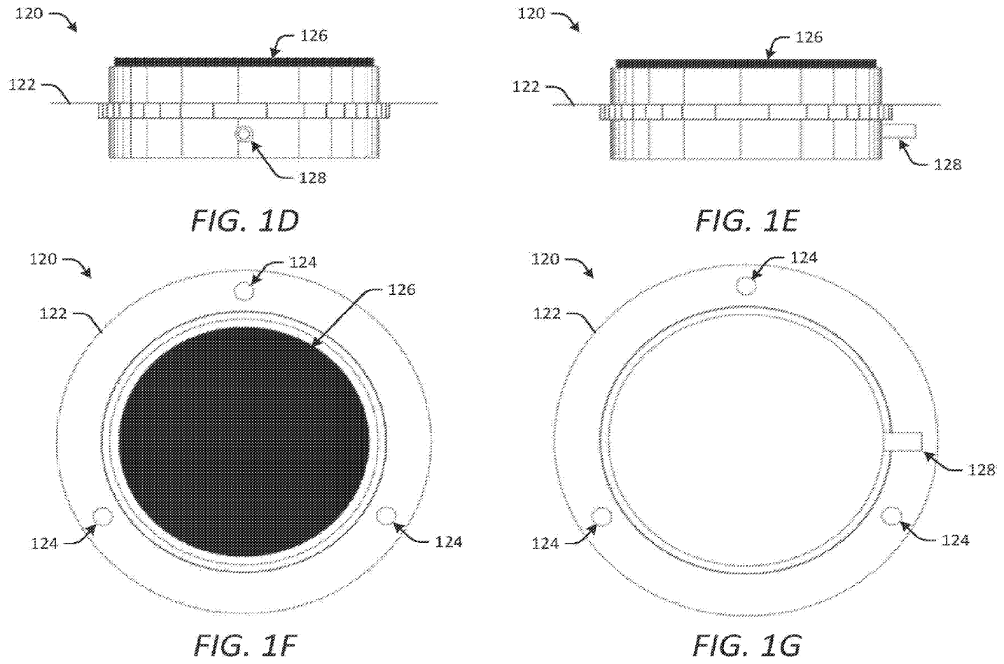

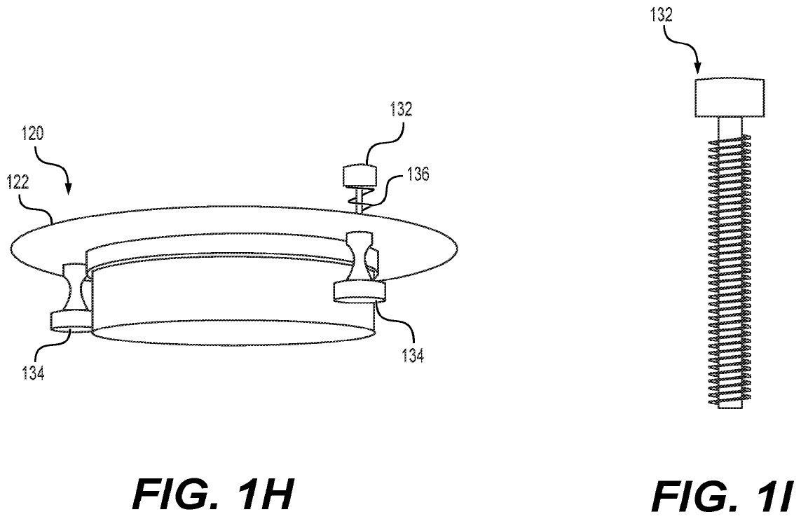

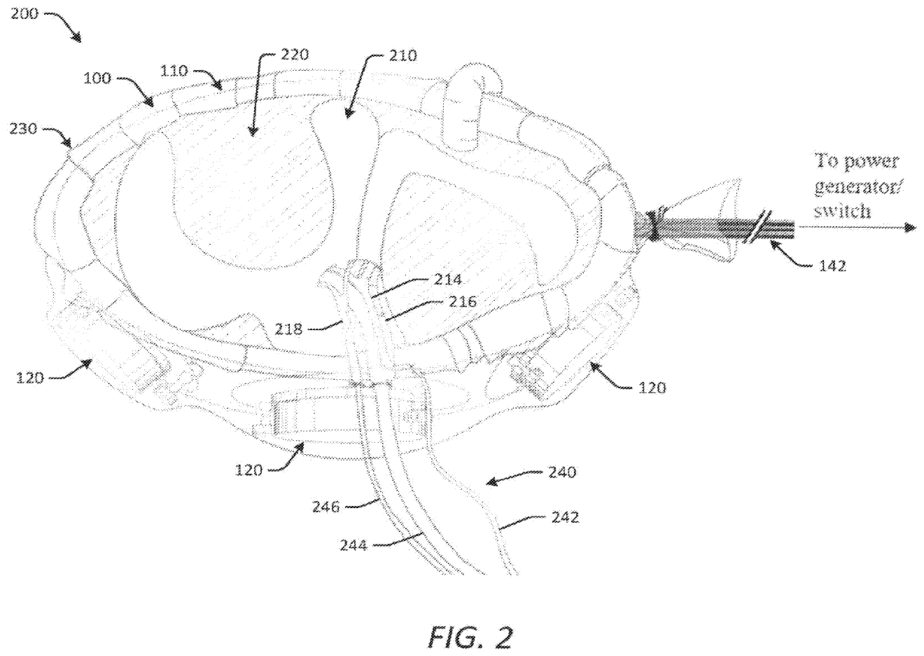

Referring now to the drawings, FIGS. 1A-1I illustrate an example device 100 for containment of an organ ex vivo and confluent distribution of an ultrasound field to the organ during ex vivo machine perfusion, as well as components of the device 100, in accordance with embodiments of the present disclosure. FIG. 2 illustrates an example use of the device 100 as part of an overall system 200 for containment of an organ ex vivo and confluent distribution of an ultrasound field to the organ during ex vivo machine perfusion in accordance with embodiments of the present disclosure. It will be appreciated that the illustrated configurations of the device 100 and the system 200 are merely examples, and that various other configurations of the device 100 and the system 200 in accordance with embodiments of the present disclosure may be used for carrying out the methods described herein.

As shown in FIGS. 1A-1C, the device 100 may include a container 110 (which also may be referred to as an “organ container,” a “basin,” or a “bowl”), a plurality of ultrasound transducers 120 (which also may be referred to as “ultrasound therapy transducers,” “ultrasound probes,” or “ultrasound therapy probes”), and a power generator 140 (which also may be referred to as an “ultrasound power generator” or a “therapy power generator”). As described herein, the container 110 may be configured for containing an organ therein, the ultrasound transducers 120 may be configured for delivering ultrasound energy to respective portions of the organ contained in the container 110, and the power generator 140 may be configured for powering the ultrasound transducers 120 to deliver ultrasound energy. FIGS. 1D-1G illustrate one of the ultrasound transducers 120, while FIGS. 1H and 1I illustrate example components that may be used for mounting the ultrasound transducers 120 to the container 110.

As shown, the container 110 may define a reservoir configured for receiving the organ therein. In some embodiments, as shown, the container 110 may be a bowl-shaped container having an open top. In some embodiments, the container 110 may have an elliptical or ovoid shape. As shown, the container 110 also may define a plurality of apertures extending through a wall of the container 110 and in communication with the reservoir. As discussed below, the apertures may allow the ultrasound transducers 120 to extend through the wall of the container 110 and into the reservoir thereof. In some embodiments, the wall of the container 110 may be rigid. In some embodiments, the overall container 110 may be rigid. In some embodiments, the wall of the container 110 may be flexible. In some embodiments, the overall container 110 may be flexible. Various sizes and dimensions of the container 110 may be used for accommodating different types and sizes of organs. In some embodiments configured for use with a liver, the container 110 have a depth within a range of 10 cm to 18 cm, a width within a range of 16 cm to 24 cm, and a length within a range of 24 cm to 32 cm. For example, the container 110 have a depth of 14 cm, a width of 20 cm, and a length of 28 cm. Various shapes, sizes, and configurations of the container 110 may be used.

As shown in FIGS. 1A-1C, the ultrasound transducers 120 may be mounted to the container 110. As shown, each of the ultrasound transducers 120 may extend through a respective aperture of the container 110 and into the reservoir thereof. In some embodiments, as shown, each of the ultrasound transducers 120 may be adjustably mounted to the container 110 such that an orientation or a position of the ultrasound transducer 120 relative to the container 110 is adjustable. For example, as shown in FIGS. 1B, 1C, and 1H, each of the ultrasound transducers 120 may be adjustably mounted to the container 110 by a plurality of threaded posts 132, a plurality of nuts 134, and a plurality of springs 136. Each of the threaded posts 132 may be fixedly mounted to the container 110 and may extend from an outer surface of the wall of the container 110 about a respective aperture of the container 110. Each of the threaded posts 132 may extend through a respective spring 136 and through a respective hole 124 defined in a flange 122 of the ultrasound transducer 120. Each of the nuts 134 may be threadedly coupled to a respective threaded post 132. Other mechanisms for adjustably mounting the ultrasonic transducers 120 to the container 110 may be used in other embodiments. Notably, the adjustability of each of the ultrasound transducers 120 relative to the container 110 may allow for adjustment of the angle of the ultrasound energy delivered by the ultrasound transducer and thus customization of the ultrasound field, for example, based on variations in organ size and shape, in order to provide confluent ultrasound coverage.

Each of the ultrasound transducers 120 may be configured for delivering ultrasound energy into the reservoir of the container 110 and to a respective portion of the organ contained therein. In some embodiments, each of the ultrasound transducers 120 may be a piezoelectric transducer configured for converting electrical energy received from the power generator 140 into ultrasound energy delivered by the ultrasound transducer 120. As shown, each of the ultrasound transducers 120 may include a transducing surface 126 from which ultrasound energy is projected. In some embodiments, as shown, each of the ultrasound transducers 120 may extend through a respective aperture of the container 110 such that the transducing surface 126 of the ultrasound transducer 120 is disposed within the reservoir of the container 110. Any number of the ultrasound transducers 120 may be used in various embodiments. According to the illustrated example, the device 100 may include twelve ultrasound transducers 120, although the device 100 may include fewer or more of the ultrasound transducers 120. In various embodiments, the device 100 may include one, two, three, four, five, six, seven, eight, nine, ten, eleven, or more of the ultrasound transducers 120. As shown, the ultrasound transducers 120 may be spaced apart from one another and arranged in an array about the reservoir of the container 110. Various configurations and arrangements of the ultrasound transducers 120 may be used to provide confluent ultrasound coverage to the organ within the reservoir of the container 110.

The power generator 140 may be in operable communication with each of the ultrasound transducers 120 and configured for selectively powering the ultrasound transducers 120 to deliver ultrasound energy to the organ within the reservoir of the container 110. In some embodiments, as shown, the power generator 140 may be in operable communication with each of the ultrasonic transducers 120 by a respective cable 142 extending from the power generator 140 to a transducer connector 128 of the ultrasonic transducer 120. The power generator 140 may be configured to provide all the functions of signal generation, power amplification, and switching. In some embodiments, the power generator 140 may be configured for selectively powering the ultrasound transducers 120 in sequence. In some embodiments, the power generator 140 may be configured for selectively powering the ultrasound transducers 120 in sequence individually (i.e., only one of the ultrasound transducers 120 is powered at a time). In some embodiments, the power generator 140 may be configured for selectively powering the ultrasound transducers 120 in sequence in multiples of two or more (i.e., two or more of the ultrasound transducers 120 are powered at a time). The sequential powering of the ultrasound transducers 120 in sequence, either individually or in multiples, may be selected to best provide confluent ultrasound coverage to the organ within the reservoir of the container 110 while minimizing interference between the ultrasound energy delivered by the ultrasound transducers 120. In some embodiments, the power generator 140 may include a switching mechanism configured for selectively switching power delivered to the ultrasound transducers 120.

FIG. 2 illustrates an example use of the device 100 as part of an overall system 200 for containment of an organ ex vivo and confluent distribution of an ultrasound field to the organ during ex vivo machine perfusion. As described further below, the device 100 may be used along with a machine perfusion system, which is configured for perfusing the organ with a perfusion solution, to form the system 200. As shown, an organ 210 may be disposed within the reservoir of the container 110. In some embodiments, as shown, the organ 210 may be a liver. In various other embodiments, the organ 210 may be a kidney, a heart, a lung, a pancreas, a small intestine, a limb or a portion of a limb, an extremity or a portion of an extremity, or a vascularized composite allograft. As shown, the organ 210 may be suspended in an organ preservation solution 220 (which also may be referred to as a “perfusion solution” in some embodiments) within the reservoir of the container 110. The organ preservation solution 220 may provide a sound-conductive medium to carry ultrasonic pulses from the ultrasonic transducers 120 to the organ 210. In some embodiments, the organ preservation solution 220 may be the same as the perfusion solution with which the organ 210 is perfused using the machine perfusion system (i.e., the machine perfusion system may be configured as an open system in which the perfusion solution drains from the organ 210 into the reservoir of the container 110 and subsequently returned to the machine perfusion circuit and recirculated). In some embodiments, the organ preservation solution 220 may be the different from the perfusion solution with which the organ 210 is perfused using the machine perfusion system (i.e., the machine perfusion system may be configured as a closed system in which all of the perfusion solution is kept internal to the organ 210 and the machine perfusion circuit while the organ 210 is suspended in the separate organ preservation solution 220). In some embodiments, as shown, a sterile bag 230 (which also may be referred to as a “sterile covering”) may be used to maintain sterility of the organ 210. As shown, the sterile 230 may cover the container 110 and the ultrasound therapy transducers 120. In this manner, the sterile bag 230 may provide the barrier between the organ 210 suspended in the organ preservation solution 230 and the container 110 and the ultrasound therapy transducers 120. Other configurations of a sterile covering, such as a sleeve or a drape, may be used in other embodiments.

As shown, the machine perfusion system may include one or more cannulas 240 configured for insertion into one or more vessels 212 of the organ 210 and directing the perfusion solution into the one or more vessels 212. In some embodiments, as shown, the machine perfusion system may include a pair of the cannulas 240 for directing the perfusion solution into a pair of vessels 212 of the organ 210. According to the illustrated example, in which the organ 210 is a liver, the machine perfusion system may include a first cannula 242 configured for insertion into a hepatic artery 214 of the liver and delivering the perfusion solution thereto, and a second cannula 244 configured for insertion into a portal vein 216 of the liver and delivering the perfusion solution thereto. The machine perfusion system may include one or more pumps coupled to the one or more cannulas 240 and configured for delivering the perfusion solution into the organ 210 via the one or more cannulas 240. In some embodiments, the machine perfusion system may include a third cannula 246 configured for insertion into a bile duct 218 of the liver for sample collection and measurement.

In some embodiments, the machine perfusion system may include one or more infusion pumps configured for infusing a microbubble-based ultrasound contrast agent into the perfusion solution used for perfusing the organ 210. The one or more infusion pumps may be configured for infusing the microbubble-based ultrasound contrast agent into the perfusion solution prior to the perfusion solution entering the organ 210. In some embodiments, the machine perfusion system may include a temperature regulator configured for regulating a temperature of the perfusion solution. In some embodiments, the machine perfusion system may include an oxygenator configured for oxygenating the perfusion solution. In some embodiments, the machine perfusion system may include one or more ultrasound imaging transducers configured for delivering ultrasound energy to at least a portion of the organ 210 for imaging the at least a portion of the organ 210, and an imaging power generator in operable communication with the one or more ultrasound imaging transducers and configured for selectively powering the one or more ultrasound imaging transducers to deliver ultrasound energy. Further details of example uses of the device 100 and the overall system 200 for containment of an organ ex vivo and confluent distribution of an ultrasound field to the organ during ex vivo machine perfusion will be appreciated from the example methods provided below.

Disclosed herein are methods for ex vivo sonothrombolysis, for example for ex vivo sonothrombolysis for a machine-perfused organ. In some embodiments, the methods may include perfusing an organ ex vivo with a solution including a microbubble-based ultrasound contrast agent and delivering one or more bursts of ultrasound energy to the perfused organ. The acoustic pressures of the ultrasound pulses may affect the microbubbles, resulting in some cases in oscillation and/or cavitation leading to disruption of clots or microthrombi in the perfused organ (sonothrombolysis) or to transient pore formation in the cell membranes within the organ (sonoporation). In some examples, the power and/or duration of the one or more bursts of ultrasound may be selected to increase clearance of blood-borne cells (e.g., RBC and/or WBC) or increase transient pore formation. In some examples, the power and/or duration of the one or more bursts of ultrasound may be selected to minimize damage to the perfused organ, for example, due to heating (thermal injury).

In some embodiments, the methods may include perfusing (for example, machine perfusing) an organ or tissue ex vivo. The organ or tissue may be perfused with an organ preservation solution (also referred to as a machine perfusion solution or perfusate). A perfusate containing one or more microbubble-based ultrasound contrast agents also may be introduced into the organ or tissue by perfusion. Without being bound by theory, continuous perfusion of solution including microbubbles may allow replenishment of the microbubbles through the organ or tissue during delivery of ultrasound. In some examples, the organ may be continuously perfused with a solution including the microbubbles. In some non-limiting examples, the microbubbles may be introduced into the perfusion solution prior to perfusion of the organ or tissue. For example, the microbubbles may be added to the perfusion solution prior to its perfusion into the organ or tissue. In one example, the microbubbles may be added to the perfusion solution entering the organ or tissue, for example, by adding the microbubbles to tubing or a catheter carrying the perfusion solution, through a side port (for example, using an infusion pump) prior to entry of the perfusion solution to an artery or vein of the tissue or organ. The microbubble infusion may occur for the duration of the machine perfusion, or for part or parts of the full duration. In one non-limiting example, livers were subjected to 4 hours of machine perfusion with microbubbles introduced for the first 15 minutes of each hour.

Microbubble-based ultrasound contrast agents have a gas core surrounded by a shell. Microbubbles are less than 10 μm in diameter and are typically smaller than red blood cells and able to enter the microcirculation (for example, about 1-4 μm in diameter). The gas core can be air, nitrogen, or a heavy gas (such as a perfluorocarbon). The shell material may be a protein (such as albumin), a sugar (such as galactose), a lipid, or a polymer. In some examples, microbubbles may have an air or octafluoropropane core surrounded by an albumin shell. In other examples, microbubbles may have a perfluorocarbon, octafluoropropane, or decafluorobutane core surrounded by a phospholipid shell. The microbubble concentration before inclusion in the perfusion solution may be on the order of but not limited to a range from 1×10⁸/ml to 1×10¹²/ml (such as about 1×10⁸-1×10¹⁰/ml, 1×10⁹-1×10¹¹/ml, or 1×10¹⁰-1×10¹²/ml). In particular non-limiting examples, the microbubbles may be included at about 1×10⁹/ml or about 1.2×10¹⁰. The perfusion rate of the microbubbles may be about 0.05 to 1.0 ml/minute (such as about 0.1, 0.2, 0.3, 0.4, or 0.5 ml/minute). The concentration of microbubbles in the perfusate may depend on the volume flow rates of the microbubble infusion and the volume flow rates of the perfusate into the organ. Other perfusion rates can be selected based on the concentration of the microbubble solution and the desired final concentration of the microbubbles in the perfusion solution. In one non-limiting example, a microbubble of octafluoropropane gas surrounded by a lipid shell (e.g., Definity® ultrasound contrast agent) may be used at a concentration of 1.2×10¹⁰/ml and perfused at a rate of 0.1 ml/minute. In another non-limiting example, a microbubble of decafluorobutane gas surrounded by a lipid shell (MP1950) may be used at a concentration of 1×10⁹/ml and perfused at a rate of 0.2 ml/minute. In some examples, the microbubbles may carry therapeutic oligonucleotides, for example, for gene therapy.

Microbubbles are commercially available and include but are not limited to Optison™ ultrasound contrast agent (GE Healthcare), Definity® ultrasound contrast agent (Lantheus Medical Imaging), Sonogen and Echogen (Sonus Pharmaceuticals), and BR38 and Sono Vue® ultrasound contrast agent (Bracco Imaging). Other microbubble formulations may be developed or in development which could be used with this ultrasound delivery device.

Following perfusion of the organ or tissue with the perfusion solution including the microbubbles, one or more bursts of ultrasound energy may be delivered to at least a portion of the organ or tissue. The ultrasound may be delivered after a sufficient period of time to allow for the perfusion solution including microbubbles to circulate through the organ or tissue. In some examples, the ultrasound may be delivered within 1 minute of introducing the solution including microbubbles to the organ or tissue. In other examples, the ultrasound may be delivered more than 1 minute (e.g., about 2, 3, 4, 5, 10, 15, 20, 30, or more minutes) after introducing the solution microbubbles to the organ or tissue. The ultrasound may be delivered at any time that the organ is undergoing perfusion with microbubbles.

The ultrasound may be delivered to at least a portion of the parenchyma of the organ or tissue being perfused with the perfusion solution including microbubbles. One or more bursts of ultrasound may be delivered to the organ or tissue. In some examples, relatively long ultrasound tone bursts (e.g., more than 4 acoustic cycles) may be used. The ultrasound frequency may range from 0.5 to 2 MHz (for example, 0.5-1 MHz, 0.75-1.25 MHz, 1-1.5 MHZ, or 1.5-2 MHz, such as 0.5, 0.75, 1, 1.1, 1.2, 1.3, 1.4, 1.5, 1.6, 1.7, 1.8, 1.9, or 2 MHz). The ultrasound frequency may be selected to match the resonance of the microbubbles that are perfused into the organ or tissue. In one non-limiting example, the ultrasound frequency may be 1.3 MHz. In some embodiments, the ultrasound may be delivered in a pulsatile fashion, for example, with a selected pulse interval over a period of time. The pulse interval may be 0.5 or more seconds, for example, 0.5-10 seconds (such as 0.5-1, 1-3, 2-4, 3-5, or 5-10 seconds). In one non-limiting example, the pulse interval may be about 3 seconds. The pulse duration may be about 0.1-5 msec (for example, about 0.1-0.5, 0.25-0.75, 0.5-1, 0.75-1.25, 1-1.5, 1.5-3, 2-4, or 3-5 msec). In one non-limiting example, the pulse duration may be 1 msec. The ultrasound may be delivered continuously or non-continuously for a selected amount of time, for example, 1-60 minutes (such as about 1-5, 2-7, 4-10, 5-15, 10-20, 15-30, or 30-60 minutes). In non-limiting examples, the treatment duration may be 5, 10, 15, or 20 minutes. A pressure amplitude (peak negative pressure) of 0.2-2 MPa may be utilized. In some examples, a peak negative pressure of 0.2-0.5, 0.35-1, 1-1.5, or 1.5-2 MPa may be used. In non-limiting examples, the peak negative pressure may be 0.35, 1.0, or 1.5 MPa. In other examples, short pulses of 3-20 cycles for high acoustic pressures over 0.5 MPa may be used or, for lower acoustic pressures, longer pulses such as more than 20 cycles, 100 cycles 1000 cycles, etc., may be used.

As described above, the ultrasound delivery and containment device (the “device”) may include an elliptical container (“bowl” or “basin”) configuration with 1 to 12 or more ultrasound transducers affixed to the bowl with transducing surfaces facing inward, each pulsing to send ultrasound waves through a portion of the volume of the organ contained within the bowl. When used with respect to a liver, concomitant with ultrasound delivery, microbubbles may be infused into the hepatic artery and/or portal vein through the entire liver during ex vivo machine perfusion. The transducers may pulse in sequence (#1, then #2, then #3, and so on) until the entire liver parenchyma has been exposed repeatedly to penetrating ultrasound waves.

In examples with two or more ultrasound probes/transducers, the ultrasound may be delivered sequentially from the two or more probes. The ultrasound may be delivered individually in sequence or as combinations sequentially such that the delivery of one or more simultaneous transducers is in a way that limits the interference of the delivered sound waves. The intent is that while one transducer is delivering ultrasound (“ON”), the other transducers are not delivering ultrasound (“OFF”) for the purposes of preventing sound wave interference while also allowing refilling of the organ vasculature with microbubbles in preparation for the next probe/transducer to pulse. For example, if the ultrasound is delivered from two transducers, the ultrasound delivery can alternate between the two transducers. If the ultrasound is delivered from three transducers, the delivery can rotate through the three transducers (such as transducer 1, transducer 2, transducer 3, transducer 1, transducer 2, transducer 3, and so on). Alternatively, the pulses may be delivered in combinations of transducers (such as 1 and 12, 2 and 11, 3 and 10, and so on).

In specific embodiments, ultrasound may be delivered with a frequency of 1.6 MHZ, a pulse interval of 3 seconds, pulse duration of 1 msec, treatment duration of 5, 10, or 20 minutes, and peak negative pressure of 0.35, 1.0, or 1.5 MPa. In one non-limiting example, the ultrasound may be delivered with a frequency of 1.6 MHz, pulse interval of 3 seconds, pulse duration of 1 msec, treatment duration of 5 minutes and peak negative pressure of 0.35 MPa. In another non-limiting example, the ultrasound may be delivered with a frequency of 1.6 MHz, pulse interval of 3 seconds, pulse duration of 1 msec, treatment duration of 5 minutes and peak negative pressure of 1.0 MPa. In an additional non-limiting example, the ultrasound may be delivered with a frequency of 1.6 MHz, pulse interval of 3 seconds, pulse duration of 1 msec, treatment duration of 5 minutes and peak negative pressure of 1.5 MPa. In yet another non-limiting example, the ultrasound may be delivered with a frequency of 1.6 MHz, pulse interval of 3 seconds, pulse duration of 1 msec, treatment duration of 10 minutes and peak negative pressure of 1.5 MPa. In a further non-limiting example, the ultrasound may be delivered with a frequency of 1.6 MHz, pulse interval of 3 seconds, pulse duration of 1 msec, treatment duration of 20 minutes and peak negative pressure of 1.5 MPa.

Methods and systems for machine perfusion of a tissue or organ include those described, for example, in International Publication No. WO 2014/059316. The disclosed methods can be used with any organ or tissue which can be machine perfused, including, but not limited to liver, kidney, heart, lung, pancreas, small intestine, or any portion thereof. In some examples, the disclosed methods can be used for more than one organ in combination, for example heart and lung(s). As used herein, the term “organ” also includes tissues, such as tissue allografts or composite tissue allografts (such as a finger, hand, arm, toe, foot, leg, face, or portion thereof).

In some embodiments, the methods may include machine perfusion of one or more organs with an oxygenated perfusion solution (such as a solution containing red blood cells). In some embodiments the temperature of the solution perfused into the organ may be between about 12-37° C. (such as about 12-30° C., 20-32° C., 20-25° C., 12-28° C., 12-25° C., 12-21° C., 15-25° C., 15-22° C., 15-21° C., 15-20° C., or 20-22° C.). In some embodiments, a sub-normothermic temperature (such as about 20-32° C.) may be selected for the perfusion solution.

In some examples, the organ is not perfused with a solution less than about 12° C., for example, the organ is not perfused with a solution having a temperature of about 11, 10, 9, 8, 7, 6, 5, 4° C. or less. The organ may be flushed with cold (for example 4-10° C.) solutions, such as lactated Ringer's solution, University of Wisconsin (UW) solution, or other solutions prior to machine perfusion or prior to transplantation into a recipient in some examples.

The perfusion solution (which in some examples also includes microbubbles) may be delivered to the organ via one or more cannulas which are inserted in a vessel of the organ (such as an artery or vein), for example a vessel that supplies blood (such as oxygenated blood) to an organ. In some examples, the microbubbles may be introduced into the perfusion solution prior to entry of the solution into a vessel of the tissue or organ, for example, through a side port in the cannula entering into the vessel. For example, a kidney may be perfused through a cannula inserted in the renal artery, while a liver may be perfused through a cannula inserted in the hepatic artery and/or a cannula inserted in the portal vein, a heart may be perfused through one or more cannulas inserted in the coronary arteries, and lungs may be perfused through one or more cannulas inserted in the pulmonary arteries. In other examples, a VCA (vascularized composite allograft, such as an extremity or face) may be perfused through a cannula inserted in an artery of the VCA. In some embodiments, the flow of the perfusion solution to the organ may be a continuous flow, such as a flow without substantial variations of flow rate, for example to mimic venous blood flow under most physiologic conditions. In other embodiments, the flow of the perfusion solution to the organ may be a pulsatile flow (such as having flow rate variations that mimic arterial pulsatile blood flow), for example, pulsatile flow of the perfusion solution through a cannula inserted in an artery of the organ or tissue. In some examples, the pulsatile flow of the perfusion solution may be with a pulse of about 50-70 beats per minute (such as about 50, 51, 52, 53, 54, 55, 56, 57, 58, 59, 60, 61, 62, 63, 64, 65, 66, 67, 68, 69, or 70 beats per minute); however, one of ordinary skill in the art can select an alternative pulse rate based on the type and condition of organ that is being perfused.

In some examples, the disclosed methods may utilize a dual perfusion technique, where the organ is perfused using simultaneous pulsatile and continuous flow. For example, the liver has two different blood supplies; the hepatic artery, which carries oxygenated blood from the circulatory system and the hepatic portal vein, which carries blood from the gut to the liver. Therefore, in some examples, the disclosed methods may include pulsatile flow perfusion of a liver through the hepatic artery and continuous (or non-pulsatile) flow perfusion of the same liver through the portal vein that more closely mimics venous blood flow. In some examples, the microbubbles may be introduced into the perfusion solution prior to entry of the solution into the hepatic artery, for example, through a side port in the cannula entering into the artery.

In some examples, the perfusate may exits the organ from one or more veins (such as the vena cava). For example, the methods may include passive venous drainage into the perfusion reservoir (open system). In other examples, a catheter may be inserted in a vein, for example the vena cava, for selective collection of fluid samples or as the return to the machine perfusion pump (closed system). The method also may include sample collection through side ports in the perfusion device (for example, for random sample collection).

Example devices and systems that can be used with the methods described herein are available from Organ Assist, Groningen, Netherlands (such as Kidney Assist or Liver Assist), Organ Recovery Systems, Itasca, IL (such as LifePort kidney transporter or liver transporter), Transmedics, Andover, MA (such as the liver, heart, or lung Organ Care System), OrganOx, Oxford, UK (such as OrganOx Metra), and XVIVO Perfusion Engelwood, CO. Example devices and systems are also described in U.S. Pat. Nos. 6,994,954; 6,953,655; 6,977,1420; 7,678,563; 7,811,808; 7,897,357; 8,268,547; 8,268,612; and 8,287,580; U.S. Publication No. 2010/0028850; and International Publication Nos. WO 2009/041806 and WO 2017/044861; all of which are incorporated herein by reference in their entirety.

In some examples, the disclosed methods may include mapping of the ultrasound field delivered to the organ and customizing the ultrasound field to the particular organ. For example, one or more ultrasound imaging transducers may be used to generate an image of the organ, and the ultrasound field may be mapped over the image of the organ to allow a clinician to see more precisely where the ultrasound is being delivered and the acoustic pressures being received by the organ. In some examples, the disclosed methods may include mapping the cavitation of the microbubbles within the organ to determine a distribution of the cavitation within the organ, allowing a clinician to assess whether the delivered ultrasound is inducing a desired amount of cavitation of the microbubbles.

Although specific embodiments of the disclosure have been described, one of ordinary skill in the art will recognize that numerous other modifications and alternative embodiments are within the scope of the disclosure. For example, while various illustrative implementations and structures have been described in accordance with embodiments of the disclosure, one of ordinary skill in the art will appreciate that numerous other modifications to the illustrative implementations and structures described herein are also within the scope of this disclosure.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments.

1. A device for containment of an organ ex vivo and confluent distribution of an ultrasound field to the organ during ex vivo machine perfusion, the device comprising:
a container defining a reservoir and a plurality of apertures extending through a wall of the container and in communication with the reservoir, the reservoir configured for receiving the organ therein;
a plurality of ultrasound transducers mounted to the container, each of the ultrasound transducers extending through a respective aperture of the plurality of apertures and configured for delivering ultrasound energy into the reservoir and to a respective portion of the organ therein; and
a power generator in operable communication with each of the ultrasound transducers and configured for selectively powering the ultrasound transducers to deliver ultrasound energy.

2. The device of claim 1, wherein the container is a bowl-shaped container having an open top.

3. (canceled)

4. (canceled)

5. (canceled)

6. The device of claim 1, wherein each of the ultrasound transducers is adjustably mounted to the container such that an orientation or a position of the ultrasound transducer relative to the container is adjustable.

7. (canceled)

8. (canceled)

9. (canceled)

10. The device of claim 1, wherein each of the ultrasound transducers comprises a transducing surface disposed within the reservoir.

11. (canceled)

12. (canceled)

13. (canceled)

14. (canceled)

15. (canceled)

16. (canceled)

17. (canceled)

18. (canceled)

19. (canceled)

20. (canceled)

21. A system for containment of an organ ex vivo and confluent distribution of an ultrasound field to the organ during ex vivo machine perfusion, the system comprising:
a container defining a reservoir and a plurality of apertures extending through a wall of the container and in communication with the reservoir, the reservoir configured for receiving the organ therein;
a plurality of ultrasound therapy transducers mounted to the container, each of the ultrasound therapy transducers extending through a respective aperture of the plurality of apertures and configured for delivering ultrasound energy into the reservoir and to a respective portion of the organ therein;
a therapy power generator in operable communication with each of the ultrasound therapy transducers and configured for selectively powering the ultrasound therapy transducers to deliver ultrasound energy; and
a machine perfusion system configured for perfusing the organ with a perfusion solution.

22. The system of claim 21, wherein the container is a bowl-shaped container having an open top.

23. (canceled)

24. (canceled)

25. (canceled)

26. The system of claim 21, wherein each of the ultrasound therapy transducers is adjustably mounted to the container such that an orientation or a position of the ultrasound therapy transducer relative to the container is adjustable.

27. (canceled)

28. (canceled)

29. (canceled)

30. The system of claim 21, wherein each of the ultrasound therapy transducers comprises a transducing surface disposed within the reservoir.

31. (canceled)

32. (canceled)

33. (canceled)

34. (canceled)

35. (canceled)

36. (canceled)

37. (canceled)

38. (canceled)

39. (canceled)

40. (canceled)

41. The system of claim 21, wherein the machine perfusion system comprises one or more perfusion pumps configured for delivering the perfusion solution into the organ.

42. The system of claim 21, wherein the machine perfusion system comprises one or more cannulas configured for insertion into one or more vessels of the organ and directing the perfusion solution into the one or more vessels.

43. The system of claim 21, wherein the machine perfusion system comprises one or more cannulas configured for insertion into one or more vessels of the organ and withdrawing the perfusion solution from the one or more vessels.

44. The system of claim 21, wherein the machine perfusion system comprises one or more cannulas configured for insertion into one or more bile ducts of the organ and withdrawing bile from the one or more bile ducts.

45. The system of claim 21, wherein the machine perfusion system comprises one or more infusion pumps configured for infusing a microbubble-based ultrasound contrast agent into the perfusion solution.

46. (canceled)

47. (canceled)

48. The system of claim 21, wherein the machine perfusion system comprises an oxygenator configured for oxygenating the perfusion solution.

49. The system of claim 21, further comprising:
one or more ultrasound imaging transducers configured for delivering ultrasound energy to at least a portion of the organ for imaging the at least a portion of the organ; and
an imaging power generator in operable communication with the one or more ultrasound imaging transducers and configured for selectively powering the one or more ultrasound imaging transducers to deliver ultrasound energy.

50. (canceled)

51. A method for containment of an organ ex vivo and confluent distribution of an ultrasound field to the organ during ex vivo machine perfusion, the method comprising:
positioning the organ within a reservoir of a container;
perfusing the organ within the reservoir with a perfusion solution comprising a microbubble-based ultrasound contrast agent; and
delivering ultrasound energy to the organ within the reservoir to induce cavitation of microbubbles of the microbubble-based ultrasound contrast agent within the organ.

52. (canceled)

53. (canceled)

54. (canceled)

55. (canceled)

56. (canceled)

57. (canceled)

58. (canceled)

59. (canceled)

60. (canceled)

61. (canceled)

62. The method of claim 51, wherein the organ is suspended in an organ preservation solution within the reservoir, and wherein the organ preservation solution is different from the perfusion solution.

63. (canceled)

64. (canceled)

65. (canceled)

66. (canceled)

67. (canceled)

68. (canceled)

69. (canceled)

70. The method of claim 51, wherein perfusing the organ within the reservoir with the perfusion solution comprises delivering the perfusion solution into the organ using one or more cannulas inserted into one or more vessels of the organ.

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. (canceled)

87. (canceled)

88. (canceled)

89. (canceled)

90. (canceled)

91. (canceled)

92. (canceled)

93. (canceled)

94. (canceled)

95. (canceled)

96. (canceled)

97. (canceled)

98. (canceled)

99. (canceled)

100. (canceled)

101. (canceled)

102. (canceled)

103. (canceled)

104. (canceled)

105. (canceled)

106. (canceled)

107. (canceled)

108. (canceled)

109. (canceled)

110. (canceled)

111. (canceled)

112. (canceled)

113. The method of claim 51, wherein delivering the ultrasound energy to the organ within the reservoir to induce cavitation of the microbubbles comprises delivering the ultrasound energy to the organ using a plurality of ultrasound therapy transducers.

114. (canceled)

115. (canceled)

116. (canceled)

117. (canceled)

118. (canceled)

119. (canceled)

120. The method of claim 113, wherein the container defines a plurality of apertures extending through a wall of the container and in communication with the reservoir, and wherein each of the ultrasound therapy transducers extends through a respective aperture of the plurality of apertures.

121. (canceled)

122. (canceled)

123. (canceled)

124. (canceled)

125. (canceled)

126. (canceled)

127. (canceled)

128. (canceled)

129. (canceled)

130. (canceled)

131. (canceled)

132. (canceled)

133. (canceled)

134. (canceled)

135. (canceled)

136. (canceled)

137. (canceled)

138. (canceled)

139. (canceled)

140. (canceled)

141. (canceled)

142. (canceled)

143. (canceled)

144. (canceled)

145. (canceled)

146. (canceled)

147. (canceled)

148. (canceled)

149. (canceled)

150. (canceled)

151. (canceled)

152. (canceled)

153. (canceled)

154. (canceled)

155. (canceled)

156. (canceled)

157. (canceled)

158. (canceled)
